(19) United States
(12) Patent Application Publication
(10) Pub. No.: US 2010/0023668 A1
(43) Pub. Date: Jan. 28, 2010

(54) COMPUTER SYSTEM HAVING MULTI-FUNCTION CARD READER MODULE WITH PCI EXPRESS INTERFACE

(76) Inventor: Lian-Chun Lee, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/251,407

(22) Filed: Oct. 14, 2008

(30) Foreign Application Priority Data
Jul. 24, 2008 (TW) 097128113

(51) Int. Cl. G06F 13/00

(52) U.S. Cl. 710/301

(57) ABSTRACT

A computer system includes a host, a PCI Express bus and a multi-function card reader module. The PCI Express bus is coupled to the host. The multi-function card reader module includes a plurality of card readers, a PCI Express interface and a PCI Express host controller. The plurality of card readers correspond to a plurality of memory card formats, respectively. The PCI Express interface is coupled to the PCI Express bus. The PCI Express host controller is coupled to the PCI Express interface and the plurality of card readers for controlling data transmission between the PCI Express interface and the plurality of card readers.

### BACKGROUND OF THE INVENTION

1. Field of the Invention

The present invention relates to a computer system, and more particularly, to a computer system having a multi-function card reader module with a PCI Express interface.

2. Description of the Prior Art

Please refer to FIG. 1. FIG. 1 is a diagram illustrating a conventional multi-function card reader module 10 with a universal serial bus (USB) interface. As shown in FIG. 1, the multi-function card reader module 10 comprises a secure digital (SD) card reader 12, a multimedia (MMC) card reader 14, a memory stick (MS) card reader 16 and an xD-picture (XD) card reader 18, for reading the data of different formats in the memory card. In addition, the multi-function card reader module 10 further comprises a USB interface 20 and a USB host controller 30. The multi-function card reader module 10 is connected with an external personal computer 40 via the USB interface 20. The USB host controller 30 is configured for controlling data transmission between the USB interface 20 and each of the card readers 12, 14, 16 and 18.

With the multi-function card reader module 10, the personal computer 40 is able to boot from an SD card, an MMC card, a memory stick (MS) card reader 16 or an xD-picture (XD) card. However, the personal computer 40 is limited to booting some particular operating systems because of the USB transmission standard. For example, the personal computer 40 is able to boot an MS-DOS operating system, but is not able to boot a Microsoft® Windows operating system, such as Windows XP or Windows Vista.

### SUMMARY OF THE INVENTION

It is therefore one of the objectives of the present invention to provide a computer system with a PCI Express interface. The computer system is able to boot Microsoft® Windows operating systems from a flash memory card via the PCI Express interface.

According to an exemplary embodiment of the present invention, a computer system is disclosed. The computer system comprises: a host; a PCI Express bus, coupled to the host; and a multi-function card reader module. The multi-function card reader module comprises: a plurality of card readers, corresponding to a plurality of memory card formats, respectively; a PCI express interface, coupled to the PCI Express bus; and a PCI express host controller, coupled to the PCI express interface and the plurality of card readers, for controlling data transmission between the PCI express interface and the plurality of card readers.

According to an exemplary embodiment of the present invention, a multi-function card reader module is disclosed. The multi-function card reader module comprises: a plurality of card readers, corresponding to a plurality of memory card formats respectively; a PCI express interface, coupled to the PCI Express bus; and a PCI express host controller, coupled to the PCI express interface and the plurality of card readers, for controlling data transmission between the PCI express interface and the plurality of card readers.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a conventional multi-function card reader module with a USB interface.

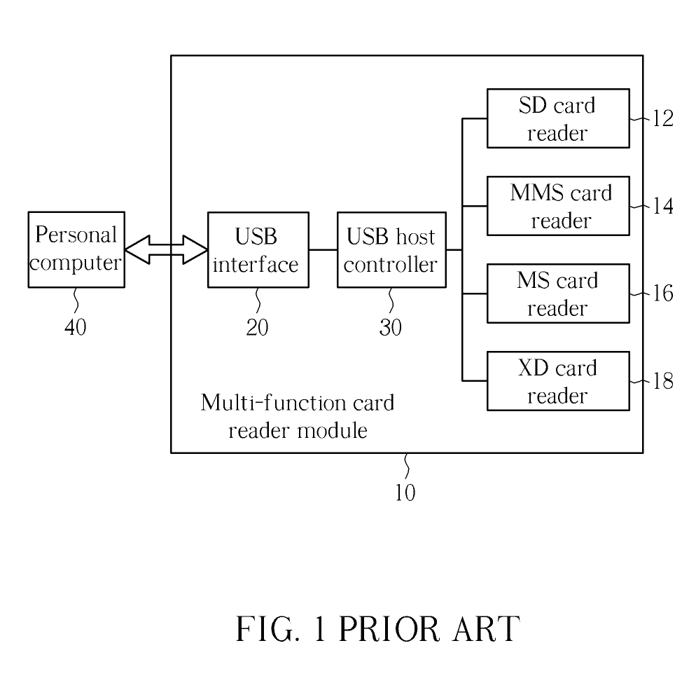

FIG. 2 is a diagram illustrating a computer system according to an embodiment of the present invention.

FIG. 3 is a diagram illustrating a multi-function card reader module according to an embodiment of the present invention.

### DETAILED DESCRIPTION

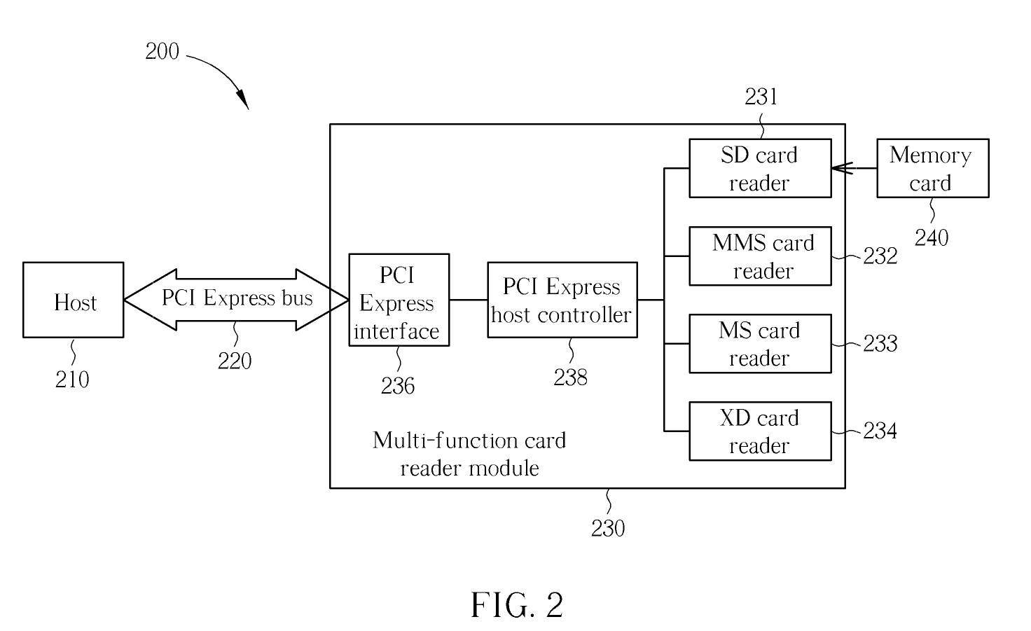

Please refer to FIG. 2. FIG. 2 is a diagram illustrating a computer system according to an embodiment of the present invention. As shown in FIG. 2, the computer system 200 comprises a host 210, a PCI Express bus 220 and a multi-function card reader module 230. The PCI Express bus 220 is coupled to the host 210. In addition, the multi-function card reader module 230 comprises a plurality of card readers 231, 232, 233, 234, a PCI Express interface 236 and a PCI Express host controller 238. The plurality of card readers 231-234 correspond to a plurality of memory card formats, respectively. The PCI Express interface 236 is coupled to the PCI Express bus 220. The PCI Express host controller 238 is coupled between the PCI Express interface 236 and the plurality of card readers 231-234 for controlling data transmission between the PCI Express interface 236 and the plurality of card readers 231-234. Further description of the computer system 200 is detailed as follows; however, this description is merely for greater clarity of understanding, and should not be taken as limiting the present invention.

As described above, the card readers 231-234 corresponds to a plurality of memory card formats, respectively. In this embodiment, the card readers 231-234 respectively correspond to a plurality of flash memory card formats, in which the card reader 231 is a secure digital (SD) card reader, the card reader 232 is a multimedia (MMC) card reader, the card reader 233 is a memory stick (MS) card reader and the card reader 234 is an xD-picture (XD) card reader. Thus, the host 210 of the computer system 200 can utilize the card readers 231, 232, 233, 234 to access the data in an SD memory card, an MMC memory card, an MS memory card and an XD memory card respectively. Please note that this is for illustrative purposes and is not a limitation of the present invention.

The computer system 200 is able to boot from a memory card 240 that complies with one of the flash memory card formats (SD, MMC, MS or XD) via the 230. Moreover, the computer system 200 is able to not only boot an MS-DOS operating system but also a Microsoft® Windows operating system since the host 210 is coupled to the 230 by the PCI Express bus 220. For example, the memory card 240 is an SD memory card in which a master boot record (MBR) and an operating system image (OS image) are stored, and the OS image is for Windows operating system such as Windows XP or Windows Vista. Because usage of the MBR and the OS image to perform a booting procedure is well known to those skilled in the art, further description is omitted for brevity.

In the abovementioned embodiment, the computer system 200 comprises a housing (not shown in FIG. 2), and the host 210, wherein the PCI Express bus 220 and the 230 are all disposed in the housing. For example, the computer system 200 may be a desktop, a laptop or an embedded system (e.g., a personal digital analysis (PDA) or a plug and play, (PNP)), and the 230 is built in the desktop, the laptop or the embedded system. This is not a limitation of the present invention. In other embodiments of the present invention, the multi-function card reader module may not be disposed in the housing of the computer system. For example, the multi-function card reader module may be a portable device and coupled to a desktop or a laptop externally.

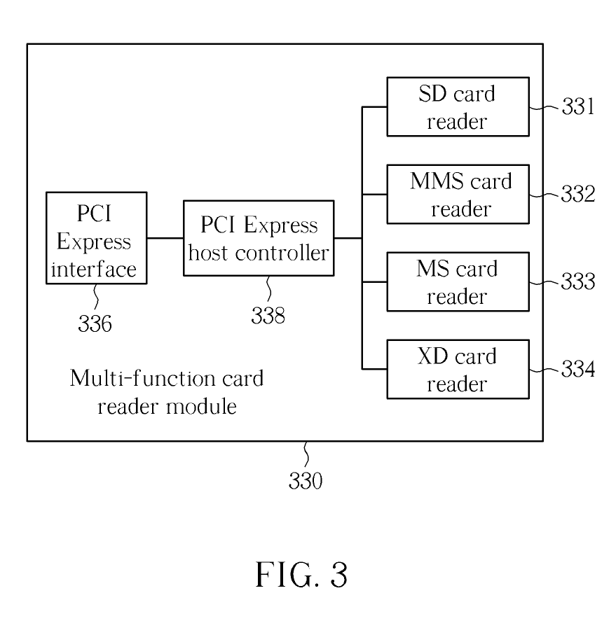

Please refer to FIG. 3. FIG. 3 is a diagram illustrating a multi-function card reader module 330 according to an embodiment of the present invention. As shown in FIG. 3, the multi-function card reader module 330 comprises a plurality of card readers 331, 332, 333, 334, a PCI Express interface 336 and a PCI Express host controller 338. The plurality of card readers 331-334 correspond to a plurality of memory card formats, respectively. The PCI Express host controller 338 is coupled between the PCI Express interface 336 and the plurality of card readers 331-334 for controlling data transmission between the PCI Express interface 336 and the plurality of card readers 331-334. In this embodiment, the card readers 331-334 respectively correspond to a plurality of flash memory card formats, in which the card reader 331 is an SD card reader, the card reader 332 is an MMC card reader, the card reader 333 is an MS card reader and the card reader 334 is an XD card reader. However, this is for illustrative purposes and is not a limitation of the present invention.

The multi-function card reader module 330 can be coupled to any electronic device with a PCI Express bus. An electronic device can utilize the card readers 331, 332, 333, 334 to access the data in an SD memory card, an MMC memory card, an MS memory card and an XD memory card, respectively, if the electronic device is coupled to the multi-function card reader module 330. In addition, if a memory card complying with one of the abovementioned memory card formats stores an MBR and an OS image, the electronic device can boot an operating system from the memory card, in which the operating system is not limited to Microsoft® Windows operating systems.

Compared with the prior art, the multi-function card reader module in the computer system of the present invention has a PCI express interface, so the host of the computer system can use a PCI express interface bus to connect to the PCI express interface of the multi-function card reader module. Therefore, the computer system of the present invention is not limited to booting particular operating systems. More specifically, the present invention is not limited to only booting MS-DOS operating systems; the computer system of the present invention also can boot Microsoft® Windows operating systems, such as Windows XP or Windows Vista. Moreover, in comparison with computer systems using PCI or USB as the transmission interface, the computer system of the present invention using PCI Express as the transmission interface requires fewer pins and has a higher frequency bandwidth.

Those skilled in the art will readily observe that numerous modifications and alterations of the device and method may be made while retaining the teachings of the invention.

What is claimed is:

1. A computer system, comprising:
a host;
a PCI Express bus, coupled to the host; and
a multi-function card reader module, comprising:
a plurality of card readers, corresponding to a plurality of memory card formats, respectively;
a PCI express interface, coupled to the PCI Express bus; and
a PCI express host controller, coupled to the PCI express interface and the plurality of card readers, for controlling data transmission between the PCI express interface and the plurality of card readers.

2. The computer system of claim 1, wherein the plurality of memory card formats are a plurality of flash memory card formats.

3. The computer system of claim 2, wherein the plurality of flash memory card formats comprise a secure digital card format (SD), a multimedia (MMC) card format, a memory stick format (MS) and an xD-picture card format (XD).

4. The computer system of claim 1, further comprising a housing, wherein the host, the PCI Express bus and the multi-function card reader module are all disposed in the housing.

5. The computer system of claim 4, being a desktop, a laptop or an embedded system.

6. The computer system of claim 1, further comprising:
a memory card, complying with one of the memory card formats, storing a master boot record (MBR) and an operating system (OS) image stored;
wherein the host fetches the MBR and the OS image via the multi-function card reader module to execute a booting procedure of the computer system.

7. The computer system of claim 6, wherein the OS image is a windows OS image.

8. A multi-function card reader module, comprising:
a plurality of card readers, corresponding to a plurality of memory card formats, respectively;
a PCI express interface, coupled to the PCI Express bus; and
a PCI express host controller, coupled to the PCI express interface and the plurality of card readers, for controlling data transmission between the PCI express interface and the plurality of card readers.

9. The computer system of claim 8, wherein the plurality of memory card formats are a plurality of flash memory card formats.

10. The computer system of claim 9, wherein the plurality of flash memory card formats comprise a secure digital card format (SD), a multimedia (MMC) card format, a memory stick format (MS) and an xD-picture card format (XD).
